(19) United States
(12) Patent Application Publication
(10) Pub. No.: US 2016/0164969 A1
(43) Pub. Date: Jun. 9, 2016

(54) Personal Computer Network, Mobile Connection and Searching Systems

(71) Applicant: Lei Li, Hummelstown, PA (US)

(72) Inventor: Lei Li, Hummelstown, PA (US)

(21) Appl. No.: 14/544,418

(22) Filed: Jan. 5, 2015

(30) Foreign Application Priority Data
Oct. 24, 2014 (TW) 103136804
Oct. 27, 2014 (US) PCT/US2014/062405

(51) Int. Cl. H04L 29/08; H04L 29/06

(52) U.S. Cl. CPC H04L 67/1095; H04L 67/02; H04L 67/06; H04L 69/08

(57) ABSTRACT

The computer users connected to the PCN logically communicate with the network through the interface. PCN centralizes all the services, functions and features, and provides the public applications, secret applications and private applications, including customized applications to the computer users. The user's computer is configured to receive all the services, functions and features from the network. Six layers of Transmission Control Protocol are defined. All TCP control the incoming data and outgoing data separately in PCN. The manuals and standard display page are designed and configured for the users to choose and switch the services. In PCN, the data structure from/to Local Server is different from the data structure flowing in the network as a feature of the network. TCP Availability Server which contains the information of status of all the protocols in the country is defined for the application servers to determine the fixed routing.

### CROSS-REFERENCE TO RELATED APPLICATION

This patent application claims the benefit of Provisional Patent Application Ser. No. 61/923,829 filed Jan. 6, 2014, entitled “Connect Mobile Network to Personal Computer Networking System” and Provisional Patent Application Ser. No. 61/962,311 filed Oct. 25, 2013, entitled “Network Architecture with Fixed Routing”, both of which are incorporated herein by reference in their entireties.

### FIELD OF INVENTION

The invention includes: the connection of mobile users 50 to Personal Computer System (PCN) and how PCN provides sufficient services to mobile users 50;

Networking computer users 10 to Personal Computer Network (PCN) with the logic connecting technologies;

The design of Network Directory in the interface 20 for both mobile users 50 and computer users 10 to define the applications in classification and geography which results in the flexible, convenient, sufficient and efficient searching systems of PCN with multiple Application Names Servers (ANS) and Server Browsers to search locally and globally in PCN;

More functions and features that PCN can provide, such as universal platform to unify different application systems, such as Windows, Mac, UNIX and so on, to make them able to work in the same network; File System 130 for mobile users to manage the files in both storage 140 and user's own computers 10; Inner Connection to communicate between two same elements in different operating system or two different elements in same operating system; and Public Branch Network Exchange used to connect the internal business network to PCN.

### BACKGROUND OF THE INVENTION

The previous application filed Oct. 27, 2014 and entitled “Network Architecture with Fixed Routing” (Ser. No. 61/962,311) indicated the inventions of the architecture of the network and the fixed routing in PCN.

With architecture of the network, mobile users 50 can access the network through the nearest operating system into the network, and logic connecting technologies is invented to connect computer users 10 globally.

Universal platform can be developed to unify different application systems to make them work in same network, and to unify the applications for mobile users 50 with Network Computing System in Mobile Unit of operating system.

File System 130 can be developed for mobile users 50 to manage the files in both storage 140 and the user's home computers 10 with PCN.

To embody the network and connect the mobile users 50, this patent application discusses Network Directory in the interface 20 to enable both computer users 10 and mobile users 50 to define the classification and geography of applications before the searching starts with multiple Application Name Servers (ANS) and Server Browsers (SB) to search locally and globally, which results in the flexible, convenient, sufficient and efficient searching systems in the PCN network based on the definition of application in classification and geography, the architecture of the network, and fixed routing.

With the definition indicated in the previous application that operating systems in the network will be identified with the country codes and area codes, and identification numbers will be defined for the elements in operating system. Same elements in different operating systems will have same identification numbers. Inner Connection can be developed to communicate between two same elements in different operating systems, or different elements in same operating system, based on the definitions of country codes, area codes and identification numbers.

PCN can be a very sophisticated network eventually. If internal business network needs to connect to PCN to share the services provided by PCN, Public Branch Network Exchange can be used to connect internal business network to the network of PCN.

### BRIEF SUMMARY OF THE INVENTION

This patent application is to network mobile users 50 to the nearest operating system and unify with computer users 10 who are networked PCN with logic connecting technologies.

PCN enables both computer users 10 and mobile users 50 to define the applications in classification and geography with Network Directory in interface 20 to develop new searching systems in the network of PCN.

This method of defining the application in classification and geography results in the flexible, convenient, sufficient and efficient searching systems in PCN, using multiple Application Name Servers (ANS) and Server Browsers (SB) to search locally and globally in the network.

This patent application focuses on the user's services of PCN, including the functions that: PCN can unify the mobile user 50 with his (her) home computers 10; Network Directory 20 results in new flexible, convenient, sufficient and efficient searching systems in PCN; PCN provides more functions and technologies which are impossible to have in Internet network, such as Inner Connections, universal platform to unify different application systems and make them able to work in the same network, such as Windows, UNIX and so on; file system 130 enables mobile users 50 to apply and manage the files in both storage 140 and the user's home computers 10; Inner Connections used to communicate efficiently in PCN; as well as internal business network can be connected to PCN network.

PCN changes some concepts of computer network and operating system. However, the change can bring our computer network to the next generation, a sophisticated and secure working environment.

### BRIEF DESCRIPTION OF FIGURES

FIG. 1 shows the architecture of Personal Computer Network, which operating systems are used to network the computer users 10 and mobile users 50 in the area, connect the application servers 40 logically. Operating systems are defined as local operating systems, regional operating systems and global operating systems.

FIG. 2 shows the module design of local operating system, which can network the personal computers 10 and mobile users 50 logically, connect application servers 40 logically and provide new searching systems to both computer users 10 and mobile users 50.

FIG. 3 shows that PCN uses star and tree topologies to integrate and network the personal computers 10 logically with centralizing/decentralizing technology.

FIG. 4 shows the simply structure of database of Network Directory 20 to define applications in classification and geography which results in the flexibility, convenience, efficiency and sufficiency of searching systems of PCN to search locally and globally.

FIG. 5 shows that PCN can provide a universal platform to unify different application systems, such as Windows, UNIX, Mac and so on into standard base and make them able to work in same network.

FIG. 6 shows that PCN can increase the security with a function of recording all the performance of both computer users 10 and mobile users 50.

FIG. 7 shows that PCN uses multiple Application Names Servers (ANS) and Server Browser (SB) to search in the network locally and globally, which results in the flexibility, convenience, sufficiency and efficiency of search.

FIG. 8 shows that Public Branch Network Exchange can be used to connect the internal business network to the network of PCN.

FIG. 9 shows the major functions of Application Control Unit 70 of operating system, including co-operating with interface, logic connections of applications, unifying of application systems, co-operating system with mobile computing system 120 and traffic control.

FIG. 10 shows the major functions of dynamic Networking Computer Unit 60, unifying mobile user to home user, verifying the home operating system user signing on the network from the foreign operating system, and recording the performance of both mobile users 50 and computer users 10 in the network.

FIG. 11 shows the flow chart of user's service of PCN, including the dynamic Networking Mobile Systems to network mobile users 50, and unify the mobile user 50 to home computers 10; Application Control Unit 70 cooperating with the interface 20 and connecting the application servers 40 in PCN; Mobile Computing System 120 cooperating with Application Control Unit and enabling the mobile user 50 to use more sufficient applications in the network; Multiple Application Names Servers (ANS) and Server Browsers (SB) in the operating systems providing new searching method collaborating and cooperating with the definition of classification and geography of applications in the interface.

FIG. 12 shows nine layers of PCN network. Among them, the layer of interface 20 is defined for both computer users 10 and mobile users 50 to develop the new searching systems of PCN.

FIG. 13 shows how three stacks of mobile user 50 compared to nine layers of computer 10.

FIG. 14 shows how Mobile Network System 110 and Mobile Computing System 120 in Mobile Unit of operating systems communicate with the mobile users 50 and other units in operating system of the network, including Network Computer Unit 60 and Application Control Unit 70 in operating system to provide all the services and applications of the network.

### DETAIL DESCRIPTION

### Architecture of Personal Computer Network

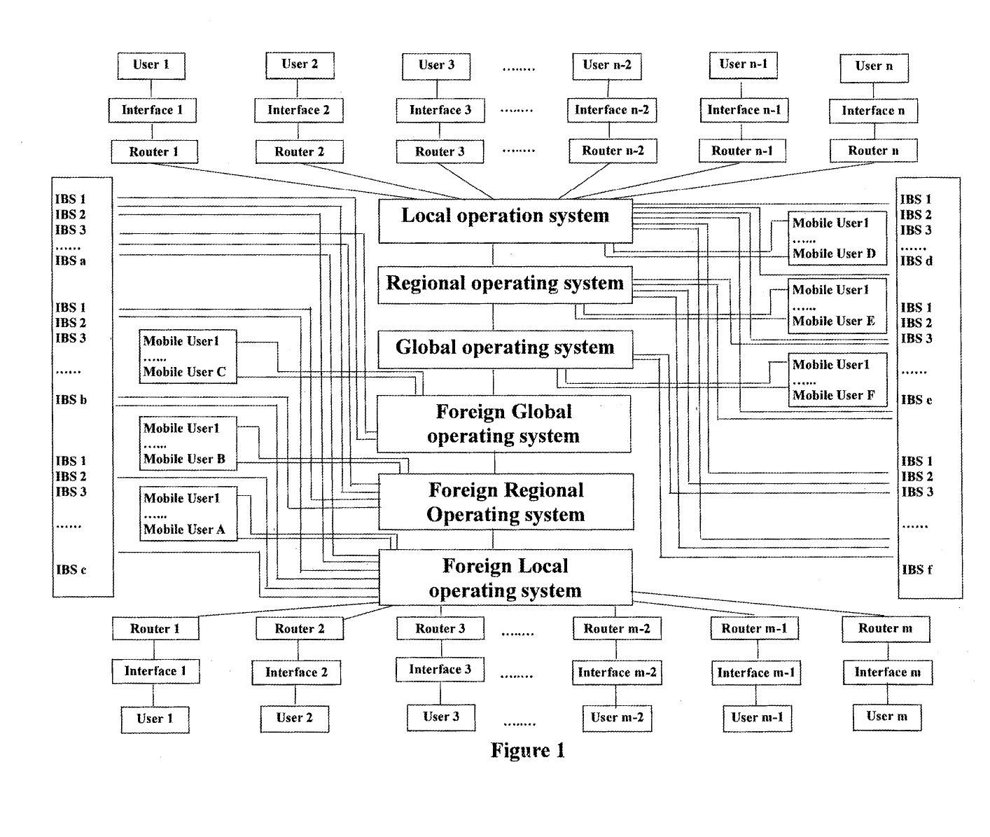

Architecture of PCN is defined as Local Operating System, Regional Operating System, and Global Operating System. They are distributed globally (shown as FIG. 1).

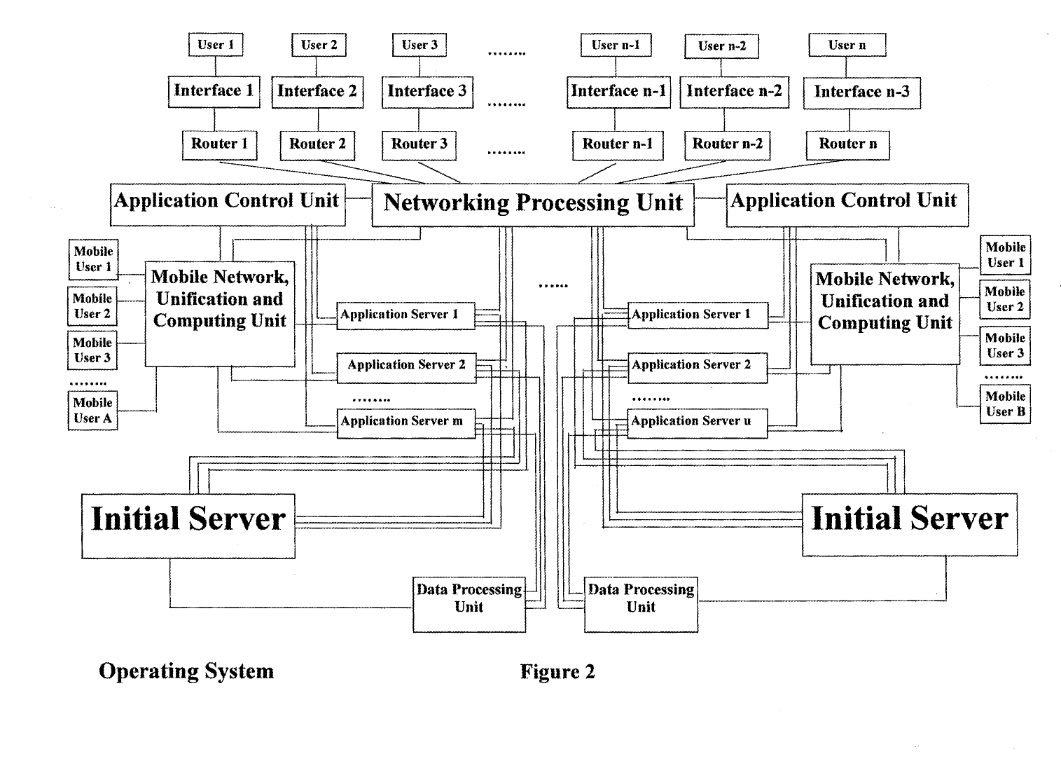

Personal Computer Network uses Local Operating Systems, Regional Operating Systems and Global Operating Systems to network the computer users 10 and mobile users 50 globally (shown as FIG. 1 and FIG. 2).

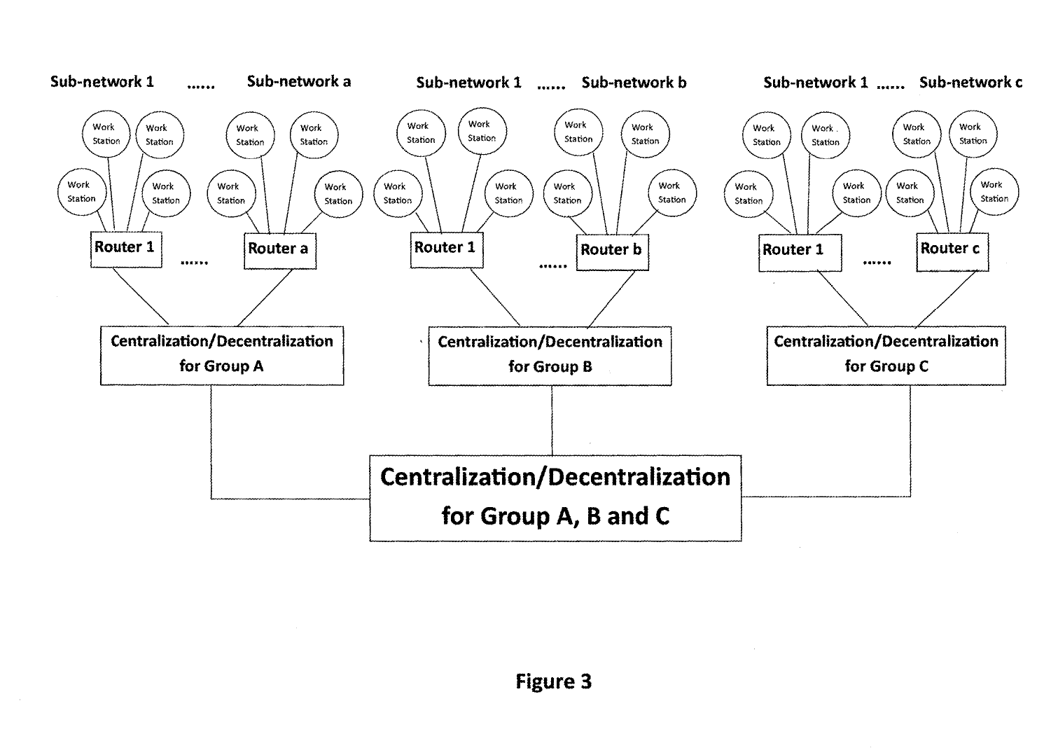

The computer users 10 are networked to PCN with logic connecting topologies (shown as FIG. 3), and the mobile users 50 can connect PCN from the nearest operating system in the network. The detailed discussion will be indicated in the sections of Topologies and Mobile Connections.

Application Server 40, also called Individual Business Server (IBS), is logically connected to PCN by Application Control Unit 70 in operating systems. The detailed discussion will be indicated in the sections of Operating System and Application Servers 40.

Mobile users 50 can connect to PCN from the nearest operating system through home agent and foreign agent of Mobile Network. After mobile user 50 is networked to PCN, PCN will assign a protocol called Network Mobile Protocol to the mobile user 50 to identify the mobile user 50 in the network. The detailed discussion will be indicated in the section of Mobile Connections.

The identification numbers are defined for all the elements in operating system. Two same elements have same identification numbers in operating systems of the network. The address of element in operating system is defined as: country code+area code+identification number.

The computer users 10 or mobile users 50 connected to the network are identified by Network User Protocol or Network Mobile Protocol in the network. The application server 40 connected to the network is identified by Network Business Protocol. The internal business network connected to the network of PCN is identified by Network Business User Protocol (NBUP).

The interface 20 between user and operating system has Network Directory which is used for bot computer users 10 and mobile users 50 to define the applications in classification and geography. The invention of Network Directory 20 results in new searching systems of flexible, convenient, sufficient and efficient local searching and global searching of the network of PCN.

The new searching systems have all applications developed in application server 40. It uses multiple Application Name Servers and Server Browsers for each application server 40 and Initial Server 80 to search locally and globally.

The application (application name) contains the code(s) of classification of the application and an identity of application server 40 which the application is at. The concept of classification of application is different from Internet network. The concept of classification in PCN is defined as accepted names of the catalogue of applications. The code(s) of classification are given to applications based on how deep the classification is defined for the applications. For example, if the code for Attorney is 100, the code for legal service of Business Law is 010. Therefore, the code of classification of general legal service applications will be 100, and the codes of classification of applications in business law will be 100 010. Here, the definition of codes of classifications has no technique meanings.

All the applications are developed in application servers 40. Companies like Microsoft can have their own application servers 40 to expand and extend their business services for both computer users 10 and mobile user 50. Some application servers 40 can combine multiple small business applications and build them in same application servers 40.

Each application server 40 has an identity in the network, so that the applications in the application server 40 can have same identity to identify themselves which application server 40 they are at in the network.

The user's computer is configured to search and employ the applications. In the interface 20, Network Directory can be developed to define the applications in classification and geography so that the searching systems of PCN can be designed flexibly, conveniently, sufficiently and efficiently to search locally inside application server 40, and globally with logical definition of geography in operating system, instead of Network Directory in the interface 20.

Operating system of PCN has a module design for expanding and extending. It is shown as FIG. 2. Application Control Unit 70 is used to connect application servers 40 logically. With the definition of classification and geography in interface 20, the applications in the application server 40 will be searched in the application server locally. However, it also can be transferred to global search with the transfer method. At mean time, global searching with Initial Server 80 of operating system can be transferred to local search inside the application server 40 any time when application server 40 is connected.

With architecture of the network and above definitions, PCN can have more functions and technologies, such as Inner Connections, Universal Platform, File System 130 for mobile users, Public Branch Network Exchange and so on. The detailed discussion will be indicated later.

As discussed in previous patent application (Ser. No. 61/962,311), the fixed routing per session of application in the network can be established based on the architecture of the network. The fixed routing is established by application which computer user 10 or mobile user 50 employs.

PCN uses different transmission system because of the definition of Local operating system, Regional operating system and Global operating system. But, the technologies of transmission can be still applied, such as cables, optical fibers, optical fibers under water and satellites.

### Topologies of PCN to Network Computer Users

In the previous application “Network Architecture with Fixed Routing”, we had n computer users in a local area that would be connected to local operating system. Now, we are discussing the topologies of the network how to network n computer users 10 to the local operating system (shown as FIG. 3).

In the topologies of the network, the n computer users 10 refer to n home sub-networks, and each home sub-networks contains multiple work stations, printer and other computerized devices at home. The topologies are networking the work stations and devices at home to local operating system with logic connecting technologies.

These n home sub-networks are divided into three groups in this patent application, for example. They are Group A, Group B and Group C. Group A has a sub-networks, Group B has b sub-networks, and Group C has c sub-networks. It is shown as FIG. 3. All the numbers of a, b and c are combined to equal to n computer users in the area to be networked to local operating system in the previous application.

At home, we can connect the all the work stations physically to the router in star. The router at home is used to function as a hub to connect the work stations at home, and the router at home is also used to function as a switch and a router to transfer and transmit the data from and to operating system. Each sub-network has a router at home. It is shown as FIG. 3.

In local operating system as indicated in this patent application, there are two layers of logic connection to integrate/disintegrate and centralize/decentralize the computer users 10. First layer has three products to integrate/disintegrate and centralize/decentralize the computer users 10 for Group A, Group B and Group C asynchronously. The second layer is to integrate/disintegrate and centralize/decentralize these three groups asynchronously to and from the final logic connecting product in operating system.

When the final central networking point is established based on the major factors of the speed and the capacity of users, computers 10 in the area can be networked logically.

The advantages of the topologies of PCN to network the computer users are that the topologies used in PCN combine the advantages of the star and tree topologies, which is easy to detect the error when it happens, and convenient to use logic connection asynchronously.

### Mobile Connections

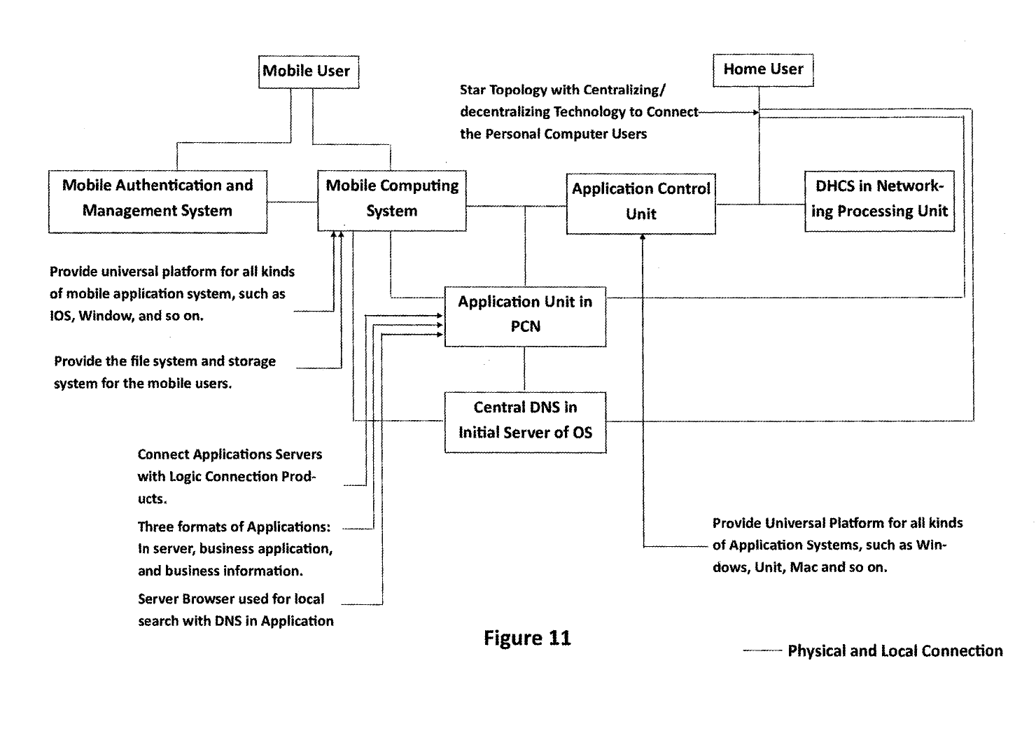

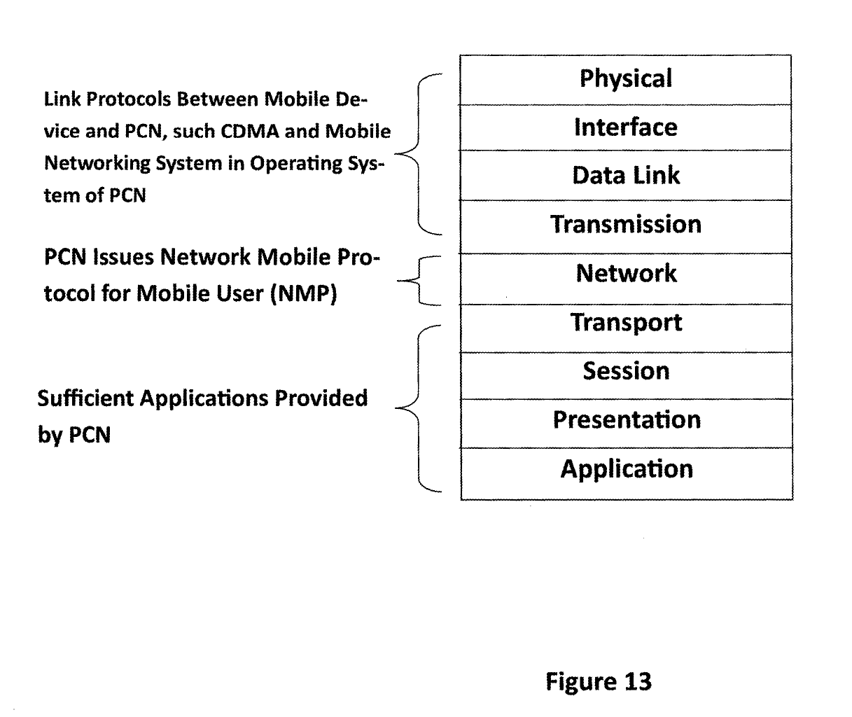

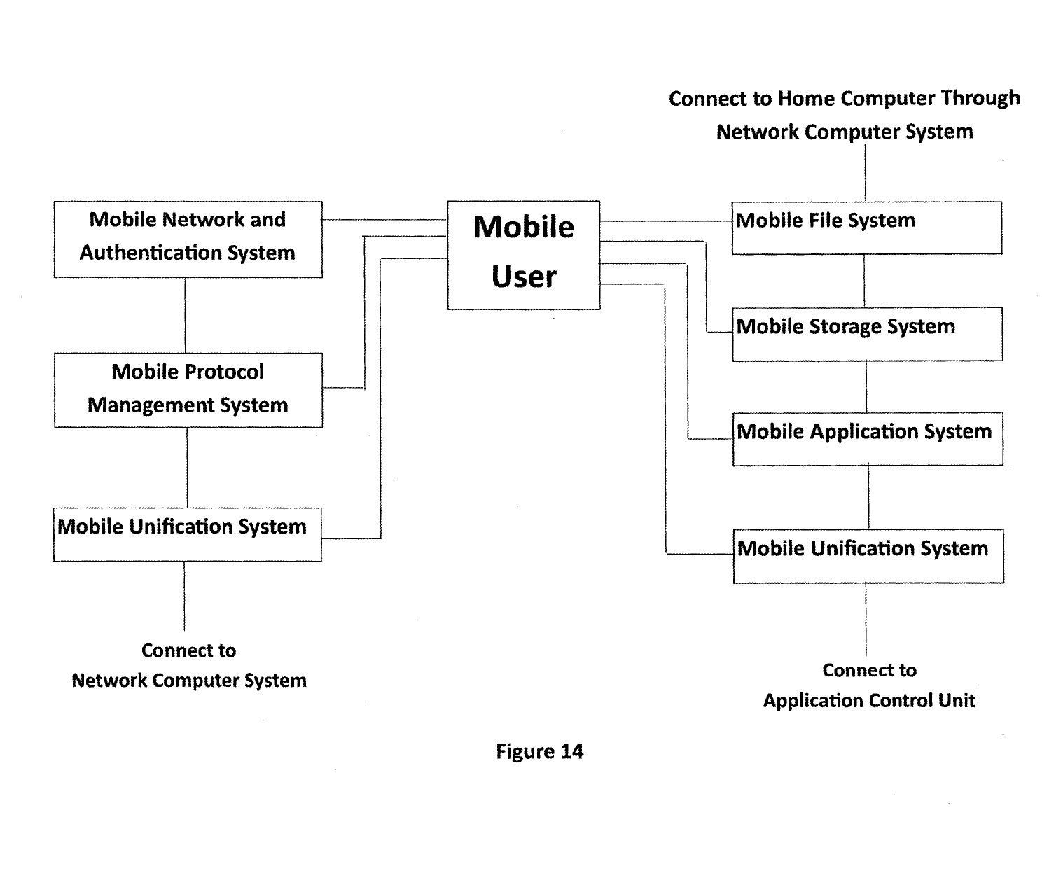

The mobile users 50 can connect to PCN network through the nearest operating system of PCN network (shown as FIG. 1, FIG. 2, FIG. 11, FIG. 13, and FIG. 14). Before mobile user 50 can connect to the network, the mobile user 50 need open an account with PCN network service provider. The account can be linked with the mobile user's 50 home computers' 10 account in order to unify the user's mobile 50 devices with his (her) home computers 10. The mobile user 50 can connect to the network through home agent, foreign agent or advertisement. It depends on where mobile user 50 is when he (she) wants to access the network.

There are two major mobile systems (shown as FIG. 14) in Mobile Unit 110 & 120 of operating system of PCN to cooperate with Network Computer Unit 60, Application Control Unit 70, Application Unit 40s and Initial Server 80 and provide all the services of PCN to mobile users 50. One is called Mobile Network System 110, and the other is called Mobile Computing System 120.

Mobile Network System 110 is configured as Network and Authenticate System, Mobile Protocol Management System and Mobile Account Unification System. Mobile Network System is to assign mobile user who is connected to the network a protocol, called Network Mobile Protocol to identify the mobile user in the network. Mobile Network System can unify with the mobile user's 10 home computers 50, and record mobile user's performance in the network.

Mobile Computing System 120 is configured as Mobile File System 30, Mobile Storage System 140, Mobile Application Unification System and Mobile Application Control System 150.

PCN can provide the mobile users 50 with File System 130 to manage the files with both the network storage system 140 and the user's home computers 10. Mobile user's 10 files are stored in mobile user's home operating system where mobile user registers.

In operating system of PCN, Mobile Unit 110 and 120 is designed to locate the user, detect the move, update the signaling and (re)establish the path, so that all the requested information can be transmitted to and from the mobile user.

The mobility of PCN can be explored in the network as much as the functions and features for the home computer users 10. Mobile Computing System 120 is designed not only to provide a file system 130 to mobile users 50 to manager and employ the files in the storage 140 and as well as home computers 10, but also to unify applications in the network to mobile users 50 and provide mobile universal platform for mobile users 50 to enable different mobile application systems to work in same network.

As same as the universal platform with a standard base for the home computers 10 to unify different application systems and make them able to work in the same network, a universal platform with a standard system can be designed to unify the applications in the network for mobile users 50 and unify different mobile application systems to work in same network.

Mobile Network System 110 can cooperate and collaborate mobile user 50 with Network Computer System 60 to unify mobile user 50 with the mobile user's home computers 10. When mobile user 50 opens a mobile network account with the service provider, the mobile user 50 can tell the service provider about his (her) home computers' account if he (she) wants to unify them. The unification between mobile user 50 and home computers 10 goes through Mobile Network System 110 and Network computer System 60 in operating system of PCN.

Mobile Computing System 120 can connect it to Application Control Unit 70 to enable mobile users 50 to use all the applications in the network after the applications are unified by Mobile Computing System 120. Employing applications of PCN for mobile users 50 will go through Mobile Computing System 120 and Application Control Unit 70 to unify all the applications of PCN for mobile users 50.

Mobile Computing System 120 can also provide mobile user 50 with storage system 140 without question. More functionally, Mobile Computing System 120 can provide mobile user 50 with a file system 130, which enables mobile user 50 to apply and manage the files in the storage system 140 in the mobile user's 50 home operating system, but also manage the files in the mobile user's 50 home computers 10. It is more convenient for the network to unify mobile user 50 to the user's home operating system and apply files stored in the mobile user's home operating system and home computers.

The functions of mobile unit 110 & 120 to locate the mobile user 50, detect the movement of mobile user 50, update signaling and (re)establish the path to communicate between mobile user 50 and network can be designed to increase the security of the mobile system. There is a limit of our human's movement. We only need to set up a reasonable parameter of the pace of our human move to detect unreasonable performance of the mobile user 50. With the verification of mobile user's Network Mobile Protocol, the illegal attack can be detected.

### Operating System

Operating system of PCN has a module design (shown as FIG. 2) to meet the requirement of expanding and extending. It contains Networking Computer Unit (NCU) 60, Application Control Unit (ACU) 70, Application Unit (AU) 40s, Mobile Unit (MU) 110 and 120, and Initial Server (IS) 80.

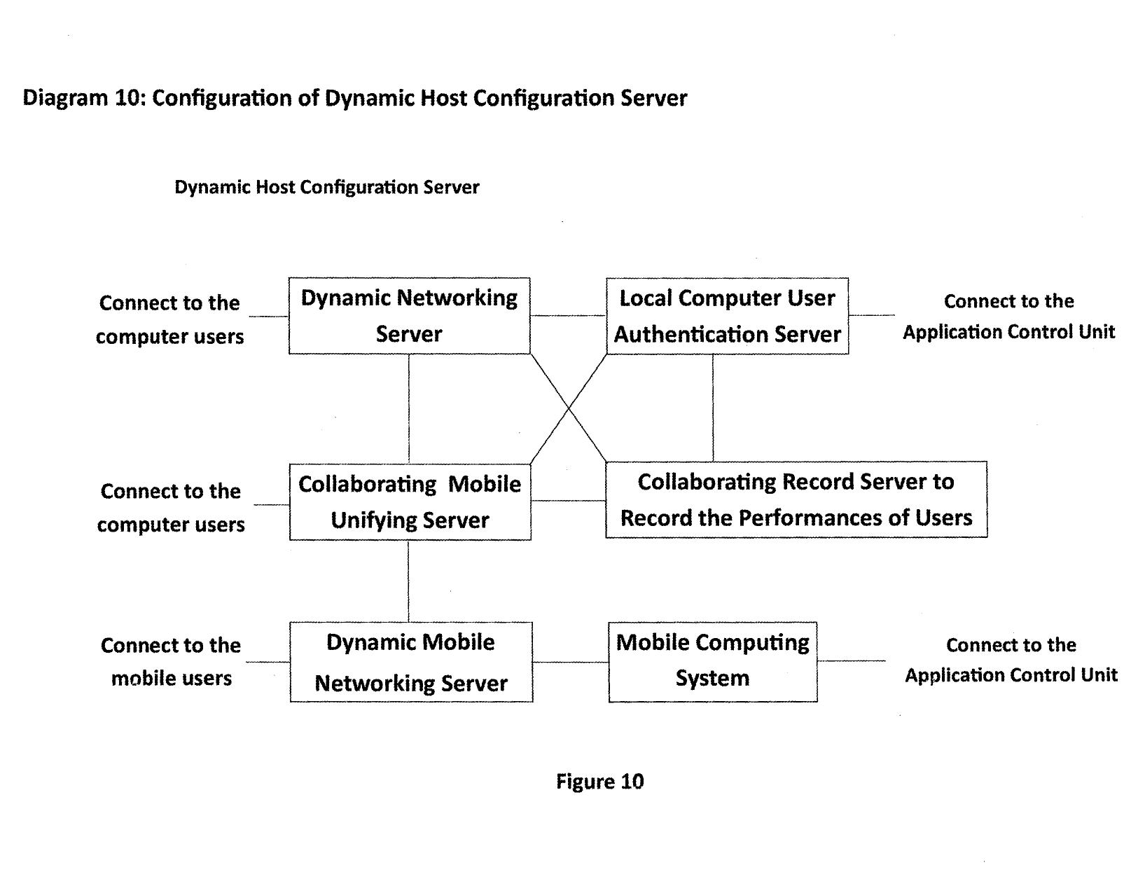

Network Computer Unit 60 (The configuration is shown as FIG. 10) has functions to network the computer users 10 in the area with the technologies of logic connection. It also authenticates the users to connect the user to the network. It provides Network User Protocol to each of user 10 after the user connects to the network. Network Computer Unit 60 of user's home operating system can also verify with other operating system when user signs onto the network from foreign operating system. Network Computer Unit 60 can also cooperate and collaborate with Mobile Network System 110 in Mobile Unit, when mobile user 50 wants to connect to the user's home computers 10, to unify the mobile user 50 to his (her) home computers 10 through user's connecting foreign operating system and the user's home operating system (Home operating system is defined as operating system which the user registers). Network Computer Unit 60 in PCN can also record all the performance of the users 10 and 50. With the feature of recording, the security of network can be improved and the network can be well managed.

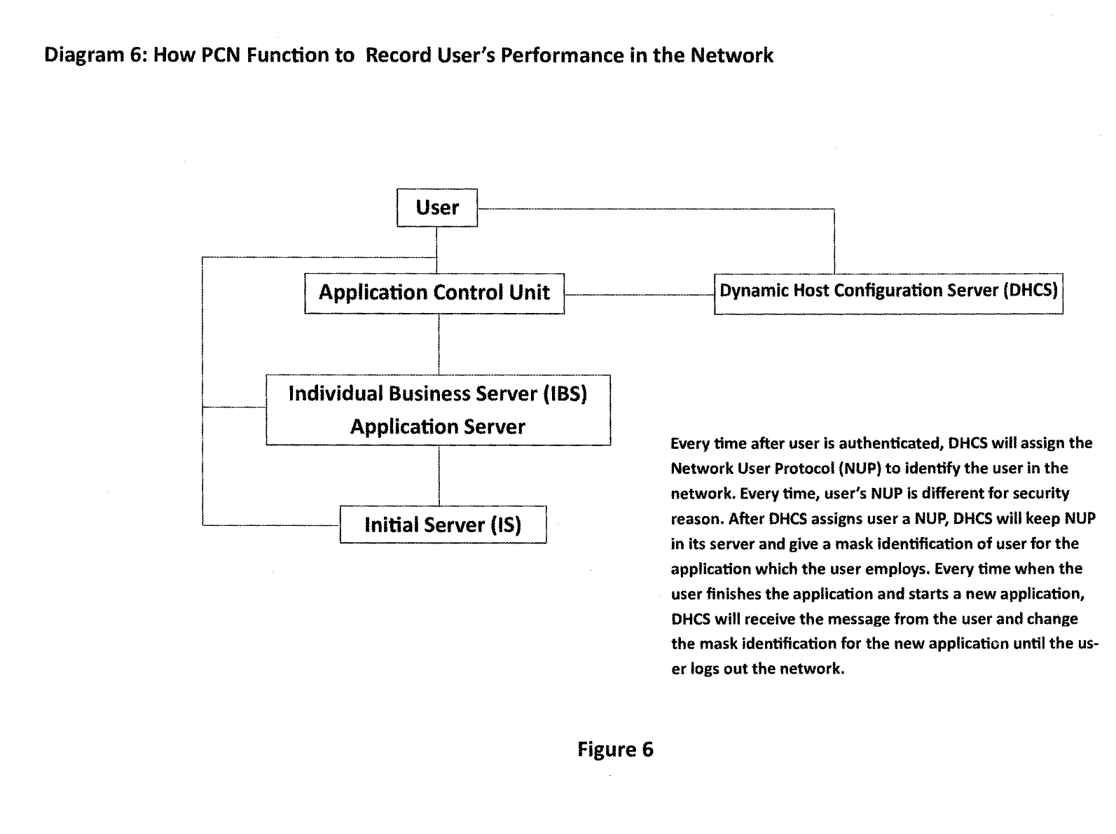

The function of recording (shown as FIG. 6) is designed based on Network User Protocol and Network Mobile Protocol assigned to the computer user 10 or mobile user 50 after they connect to the network. Every time when computer user 10 or mobile user 50 connects to the network, PCN will assign the user a protocol to identify the user in the network. Every time when the user connects to the network, the assigned protocol is different for security reason.

After Network Computer Unit assigns the protocol to the user 10, Network Computer Unit will keep the user's real identity in the unit, and give a mask identity of user to employ applications. Every time when the user finishes the application and starts new application, Network Computer Unit 60 will receive the message from the user 10 and change the mask identity for new application until the user signs out the network. By providing user's mask identity and recording user's performance in the network, the security of PCN can be improved as well.

Network Mobile Unit 110 and 120 used to network mobile users 50 has same function to record the mobile user's 50 performance in the network. Network Mobile System 110 in Mobile Unit 110 and 120 will assign a protocol to mobile user to identify the mobile user 50 in the network. Network Mobile System 110 in Mobile Unit 110 and 120 will keep mobile user's 50 identity and give a mask identity of user to employ the application. Every time when mobile user changes application, Network Mobile System 110 will be given a message and change the identity of user for new application until the user signs out the network. In this way, the security of both PCN and mobile network can be improved together.

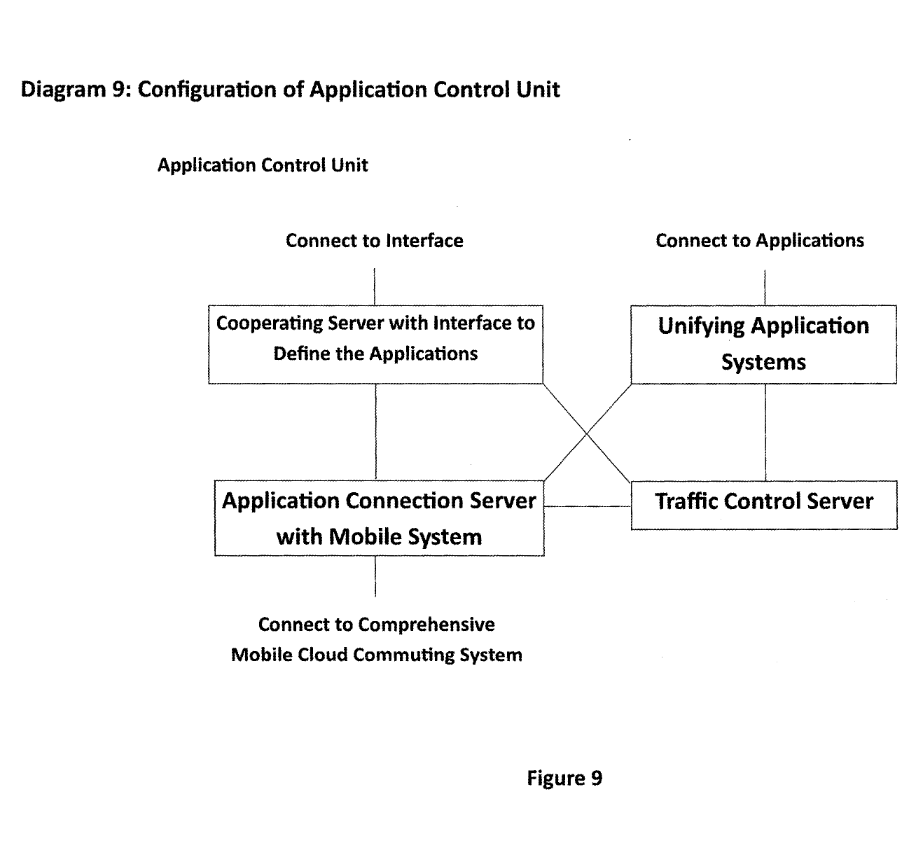

Application Control Unit 70 (the configuration is shown as FIG. 9) in operating system (shown as FIG. 2) connects the Network Directory in the interface 20 which both computer users 10 and mobile users 50 can use to define the classification and geography of application before the searching starts, and analyzes the codes of defined classification and geography of application with the country code and area code to find applications. Then, application connection server in Application Control Unit 70 connects the applications by the code of defined classification containing in applications' identification numbers geographically.

Application Control Unit 70 also provides a universal platform (shown as FIG. 6) to enable the different application systems, such as Windows, UNIX, and Mac and so on to work in the same network. The universal platform consists of a standard base that different application system can be converted to with the interface 20.

Application Control Unit 70 can unify all the applications in the network with Mobile Unification System 150 in Mobile Computing System 120 to provide all the applications in the network to mobile users 50 as well.

Application Unit 40s in operating system is designed for Application Servers 40 in the area. It can be designed to be easily well expanded and extended in the network, because all the applications in the network of PCN will be developed in application servers 40. All the application servers 40 have identities, and the applications in the server will have the identity of the application server 40 to identify them which application server 40 the application is at. At mean time, part of identification number of the application contain the code(s) of the classification by which Application Control Unit 70 can search after analyzing the code(s) of classification and geography that user 10 or 50 defines in the interface with Network Directory 20.

Each application has an application name for both computer users 10 and mobile user 50 to search. Application server 40 with multiple applications contains its own Application Name Server (ANS) and server browser to search the applications or sub-applications in the server locally. Sub-applications are applied when the application server only has single application in the server. Local search can be converted to global search with the indication behind the underlined link and Inner Connection between two server browsers in same operating system or different operating systems. The indication leads the local searching to global searching.

Initial Server 80 of operating system basically searches globally with search engine in Server Browser, after computer user 10 or mobile user 50 doesn't define the application in classification and geography at Network Directory 20. Instead, they search with Application Name. The identification number of application name contains the code of classification as well. Application Control Unit 70 sends the request to Initial Server 80 after analyzing the code of application, searching engine in Initial Server 80 of operating system retrieve the applications by code of classification with the definition of geography to search globally. Global search can be transferred to local search.

For more efficient search, it is better for application server 40 to define its coverage in the network, so that Initial Server 80 of operating system can define the application in geography easily and efficiently.

Application Unit 40s is for Application Servers 40 connected to operating system. In PCN, each application has a name, and each application server 40 has a name too. For both computer users 10 and mobile users 50, they don't need to know Application Server Name. They only need to know Application Name.

Application Server Name can be one of its application names. They are same literately, but their concepts are different, and their addresses are different, either.

Mobile Units 110 and 120 consists of Mobile Network System 110 and Mobile Computing system 120 (shown as FIG. 14). The Mobile Network System 110 is designed to connect mobile user 50 from digital system like CDMA, locate mobile user 50, detect user's 50 movement, update mobile user's 50 signaling and (re)establish the path to communicate with mobile user 50.

After mobile user 50 is connected to the network, Mobile Network System 110 provides the mobile user 50 with Network Mobile Protocol to identify the mobile user 50 in the network. Mobile Network System 110 also can unify the mobile user 50 with the user's home computers 10 and record the performance of mobile user 50 in the network until the mobile user 50 signs out.

Mobile Computing System 120 of PCN can provide mobile users 50 with the file system 130, storage system 140 and sufficient application services of PCN. The file system 130 enables the mobile user 50 to manage the files in both storage 140 and user's home computers 10. Mobile Computing System 120 can also unify the applications in PCN to mobile users 50 and provide universal platform for different mobile application systems.

### Interface

The computers 10 and mobile devices 50 in PCN are configured to search applications and employ the applications. The interface 20 between user 10 and 50 and operating system enables user 10 and 50 to employ all the applications in the network, as well as to manage, control and maintain all the files from the applications (shown as FIG. 1 and FIG. 2).

Here, we discuss Network Directory in the interface 20 which can be designed for both computer users 10 and mobile users 50 of PCN to define the applications in classification and geography, so that new flexible, convenient, sufficient and efficient searching systems can be developed in PCN to search locally and globally.

In PCN, the applications for users 10 and 50 to employ can be located in different countries or areas. Although Application Control Unit 70, Application Name Server (ANS) and server browser and Initial Server 80 in operating system can control and search globally, the design of Network Directory in the interface 20 enables the user to define the applications in classification and geography, so that the searching systems in PCN can be designed flexibly, conveniently, sufficiently and efficiently to have local search with Application Control Unit 70, ANS and server browser in Application Server 40.

For example, the application of Microsoft can be employed as long as the user enters the name of the application anywhere in the network if Microsoft covers entire network. However, different users 10 and 50 in different locations could have different application of Microsoft. If the user in China wants to know what Microsoft application is in the United States, the user 10 and 50 in China can define the location first, and then enter the name of application. PCN will take the user to the country of the United States and show the user what Microsoft application is in the United States.

It is same for user 10 and 50 to define the classification. After user defines the location of United States in geography, if he doesn't know which application he can employ to find the companies like Microsoft Corp., PCN provides the user with searching manner which is to search by the classification, Application Name, key words of application, or subject. For this case, the user only needs to define the classification of “Major Computer Corporations” to fine Microsoft Corp.

Network Directory 20 basically is a database, containing all the classifications and geography of the applications which are used to define the applications in classification and geography and to establish new searching systems to search locally and globally. Database also contains Application Names. There are code(s) of classification to define the classification of the application. Application Name can be used to define the classification of application, and also is a component of Application Name Server. But, in the database of Network Directory 20, application name also has the code(s) of classification of application in its identification number, which is used for searching applications. The geography is defined by the country code and area code, and as deep as zip codes.

The identification number, country code and area code have been discussed in the previous patent application “Network Architecture with Fixed Routing” (Ser. No: 61/962,311).

The codes of classifications are defined according to the accepted names of catalogues. For example, Attorney is defined as general legal service as 100, and specialized legal service, like business law is defined as 100 001, while Physician is defined as medical doctor as 200, and specialized dermatologist can be defined as 200 030.

The code(s) of classification will be part of the identification number of the application. In this case, the identification numbers of applications of legal services in Business Law contain the classification codes of 100 001, while the dermatological applications contain the classification codes of 200 030 in their identification numbers of applications. There is no technique meaning of these codes of classifications.

The relationship between the code(s) of classification and identification number of the application is that code(s) of classification is part of identification number of application and Application Control Unit 70 connected to Network Directory 20 uses code(s) of classification to fine the applications which contain the code(s) of classification defined by user 10 in Network Directory 20.

The defined geography will be identified with the country code and area code by Application Control Unit 70 in operating system to locate operating system to search and to find all the applications containing the code(s) of the defined classification in defined location in the network.

The classification of applications used to find application in the interface is different from application name defined to search in PCN, even though they could be same literately sometimes. Their concepts in PCN are different. The name of classification used to define the classification of applications has code(s) and by which Application Control Unit 70 uses to search applications, while application name used to search the application has an address in the network. Application name is not only a component of Application Name Server (ANS), which server browser uses it to search locally and globally in the network of PCN, but also a component of Application Server 40 which is connected logically to the network of PCN and searched locally and globally in the network of PCN.

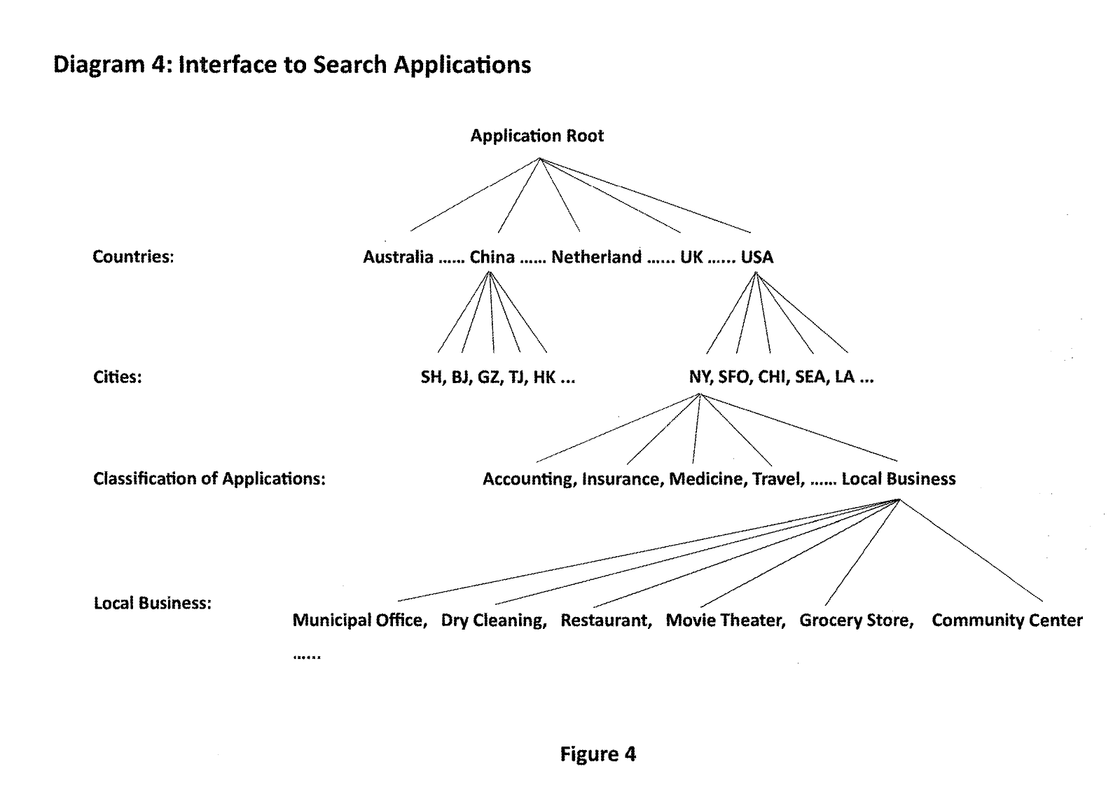

The simplest structure of database can be designed as shown in FIG. 4. We can have three search boxes for users 10 to define the applications in classification and geography separately, or search with application name in Network Directory 20. For geography, PCN network enables users to define the location with the country name, city name, as deep as the zip code which users can find its zip code directly by typing “zip code of Ferguson, St. Louis, Mo.” in search box in Network Directory 20.

The zip code defining application geographically will be interpreted by Application Control Unit 70 into the country code and area code to locate operating system. Although the zip code is used to define geography, it will become part of identification number of application sometimes, like the code of classification. It is because operating system with country code and area code can cover large area that has multiple zip codes in the area. Zip code can't be used to identify operating system in the network. But, it can be used to identify the applications or application servers in operating system (defined by country code and area code after interpreting the zip code).

For example, there are three zip codes in the area that operating system with country code 001 and area code 717 covers. They are 17033, 17109 and 17111. If we have three applications of “Local Business” for these locations with the different zip codes, the zip code can be used to identify the application server of “Local Business” for different area with the different zip code. Therefore, the zip code should be indicated in the identification number for the applications and application server of “Local Business” for the areas with three different zip codes, although the zip code is used to define the geography of applications.

The database of Network Directory 20 is connected to Application Control Unit (ACU) 70 which can analyze the code(s) of classification and country code and area code of defined geography to find the defined applications. After finding the applications, ACU will connect the application servers 40 logically in the defined geography.

After the user 10 defines application in classification and geography in the interface, PCN will conduct the search locally first in flexible, convenient, sufficient and efficient manner. Local search can be transferred to globally search. The conversion occurs with the configuration of the computer and the network, so that user can re-define the classification and geography anytime to convert the search between local and global. Searching by Application Name without definition of geography result in global searching and global searching can be transferred to local search too.

Now, it can be declared that there are two searching manners in PCN: One is to use Application Name Server in Application Server 40 to search locally after application is defined in classification and geography; and the other is to search globally when it relies on Initial Server 80 to define the geography.

To make the searching system even more efficient, we can define the coverage of applications and application servers in the network of PCN, although the application server 40, like “Local Business”, is not necessarily defined the coverage in the network of PCN. When user wants to find it, they will define the classification and geography of the application to search locally. However, the major companies, like “Microsoft”, are very necessarily defined the coverage in the network of PCN.

### Searching System of PCN

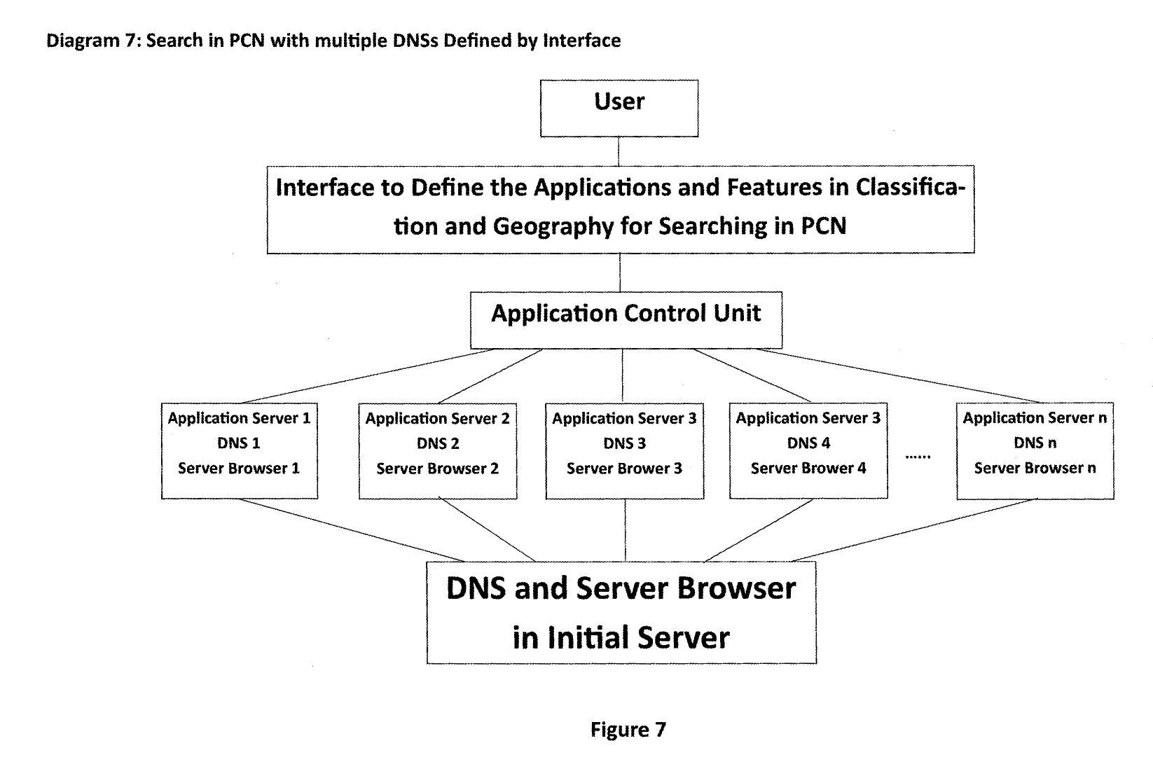

Searching in PCN is different from Internet network, because of the advantages that PCN provide us with the Network Directory in the interface 20 which enable both computer users 10 and mobile users 50 to define the applications in classification and geography before PCN starts searching. The advantages of Network Directory 20 provide us with the new searching systems to empower the network to search information flexibility, conveniently, sufficiently and efficiently (shown as FIG. 7) with multiple Application Name Servers (ANS) and Server Browsers (SB).

The searching systems of the network of PCN consist of Network Directory 20, Application Control Unit 70, Application Servers 40, Applications, Initial Servers 80 and multiple Application Name Servers (ANS) and Server Browsers (SB).

Network Directory 20 basically is a database. It has three searching boxes for users 10 to define the application in classification and geography. The first and second boxes are used for users 10 to define the classification and geography of the application. The third searching box is for user 10 to search with application name. Application name used to search in Network Directory 20 has the code(s) of classification behind it.

All applications in the network of PCN are developed in application servers 40. Each application server 40 has a name, identity and address. The applications in the application server 40 will have the identity of the application server to identify themselves which application server they are at.

Application has a name, and application server 40 has a name, too. Application server's 40 name can be duplicated in the network of PCN and the computer users 10 and mobile users 50 don't have to know the name of application server 40. However, two application servers 40 with same name have different identity and addresses in the network of PCN.

Same application can be in different application servers 40. However, the application needs to have all the identities of application servers to identify itself which application servers 40 they are at.

Application name is unique in the network of PCN. Application name can't be duplicated. The computer users 10 or mobile users 50 don't need to know the name of application server. But, they can remember application name to search. If users don't know application name, they can define the application in classification and geography to search.

Application Name Server contains application names. Each application name has its address in the network, each address of application has its identification number, each identification number of application has classification code(s), and each application has an identity indicating which Application Server the application is at.

Application Server's 40 name could be same as one of its applications in the server, and application server's 40 name can be duplicated in the network of PCN. However, duplicated named application servers have different addresses in the network of PCN. Application name in the network of PCN is unique unless the application is defined and unique locally only.

Application Server 40 has an identity to identify itself in the network. Application Server 40 will be given a protocol, called Network Business Protocol after it is connected to the network of PCN. All the applications in the application server 40 have the identity of the application server 40 to identify themselves which application server they are at.

The identification number of application contains the code(s) of classification which the searching systems of the network of PCN can rely on to search.

Network Directory 20 is connected to Application Control Unit (ACU) 70 and Initial Server (IS) 80 for local search and global search. After user defines the classification and geography of application, ACU 70 or IS will analyze the definition of classification and geography, and search for the applications with the code(s) of classification in defined geography.

For example, if the definition says that user needs to find a dermatologist in San Francisco, United States (country code 001, area code 415 and classification codes 200 030), Application Control Unit 70 in user's operating system will inner-connect to Application Control Unit 70 in San Francisco. Application Control Unit 70 in San Francisco uses server browser and ANS to connect all the applications of dermatological services by classification code of 200 030 in the identification numbers of applications and connect them to start local search.

Local search begins after both classification and geography are defined at Network Directory 20. With the definition of classification and geography of applications, Application Control Unit 70 connects the application servers 70 which the applications containing defined classification code(s), and local search begins in the searched application server 70.

Local search can be converted to global search any time with a new defining method configured in the computer and network to define classification and geography again. With the new defining method configured in the computer, local search can also be converted to another local search or global search

Global search begins when user only defines the classification. Without definition of geography at Network Directory 20 or new defining method configured in the computer and network, the network of PCN will define the geography logically to start global search.

Global search can also be converted to local search by the configuration of the computer. The detailed design of the conversion between local search and global search with the configuration of the computer and the network will be submitted in another application.

Multiple Server Browser (SB) and Application Name Server (ANS) are used in the network of PCN to search. Server Browser and ANS are developed in each Application Server 40.

The communication between two server browsers can user Inner Connection efficiently. If these two server browsers are in same location with same country code and area code, the inner-connection can take place after changing the identification number of the receiving server browser to determine the address. If these two server browsers are same browser, but in different location, the inner-connection can take place after changing the country code and area of the receiving server browser to determine the address.

The searching systems of PCN can always present the user with the Application Names in the orders of alphabet, size of business, distance of business or popularity.

As known, the design of Network Directory 20 enables both computer users 10 and mobile users 50 to define the classification and geography of the application which results in the flexible, convenient, sufficient and efficient searching systems of PCN.

The flexibility of searching systems in PCN is based on the design of Network Directory 20. Network Directory 20 can be designed for both computer users 10 and mobile users 50 not only to define applications in classifications and geography, but also to use application name, key words or subject to search. When user is determined what to search and where to search, PCN can specifically search the classified application in the defined location locally. At mean time, the flexibility of PCN searching system enables both computer user 10 and mobile users 50 search directly without defining the classification and geography of application globally. Local search and global search can be converted by the underlined links in application pages based on the addresses behind the links.

The convenience of searching in PCN is designed by searching boxes in Network Directory in the interface 20. One box is used to define the classification, and the second box is used to define geography for searching application. The third searching box is used to directly search not only application, but also other known applications, such as zip codes of world. The result can be presented in the order of alphabet, distance, business size or popularity, and so on.

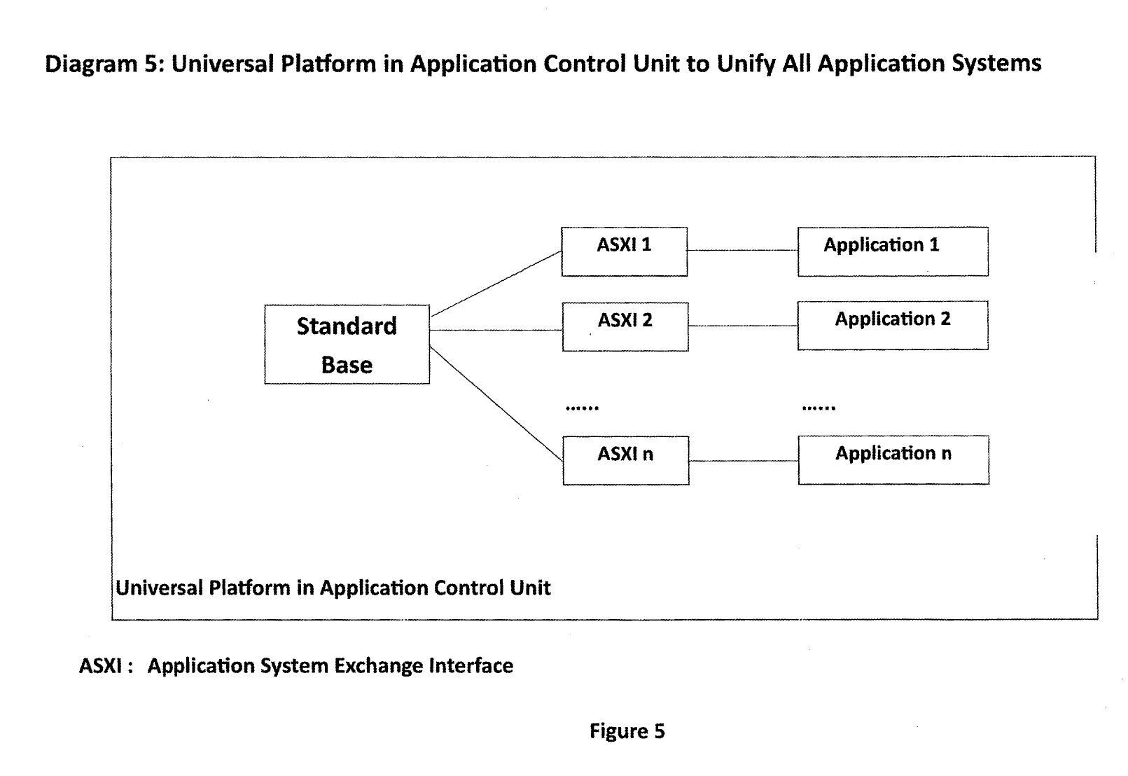

The sufficiency of PCN can be developed with the universal platform (shown as FIG. 5) which enables all kinds of application systems to work in the same network, such as Windows, Mac or UNIX and so on. The sufficiency can also be developed for mobile users 50 after all the applications in the network of PCN can be unified for mobile users. The universal platform can be developed to have a standard base and convert different kinds of application systems to the standard base of universal platform. The universal platform is developed in the Application Control Unit 70 of operating system. Different application systems can be converted into to standard platform after the application server 40 is connected. The configuration of Application Control Unit 70 is shown as FIG. 9.

The efficiency of using PCN can be developed by both user's services and network performance based on the architecture of the network, features and technologies of the network, such as Logical networking Technologies, Network Directory 20, Inner Connection, and fixed routing. Network Directory 20 provides the network with an efficient search manner by defining classification and geography of applications. PCN can provide more technologies, such as multiple Application Name Servers and Server Browsers to establish local searching and global searching efficiently in the network of PCN.

For example, when the computer user 10 need employ one of the applications in the application server 40 of “Local Business” in own area, the computer use 10 can directly go to Local Business to find the application he (she) wants to employ; For the network, the search will stay only in local operating system and there is no need to go anywhere in the network.

Server browser in the application server 40 can not only search for the information, but also be used to communicate with other server browser with the manner called Inner Connection, which is a unique feature of PCN. It is designed based on the fact that same elements in operating system in different location have same identification numbers, which makes two same elements only have country code and area code different in their addresses. It is very efficient to communicate between two same elements in different locations, which only need to change their country code and area code in the address. The feature of Inner Connection makes PCN searching systems very efficient as well.

### Layers of PCN

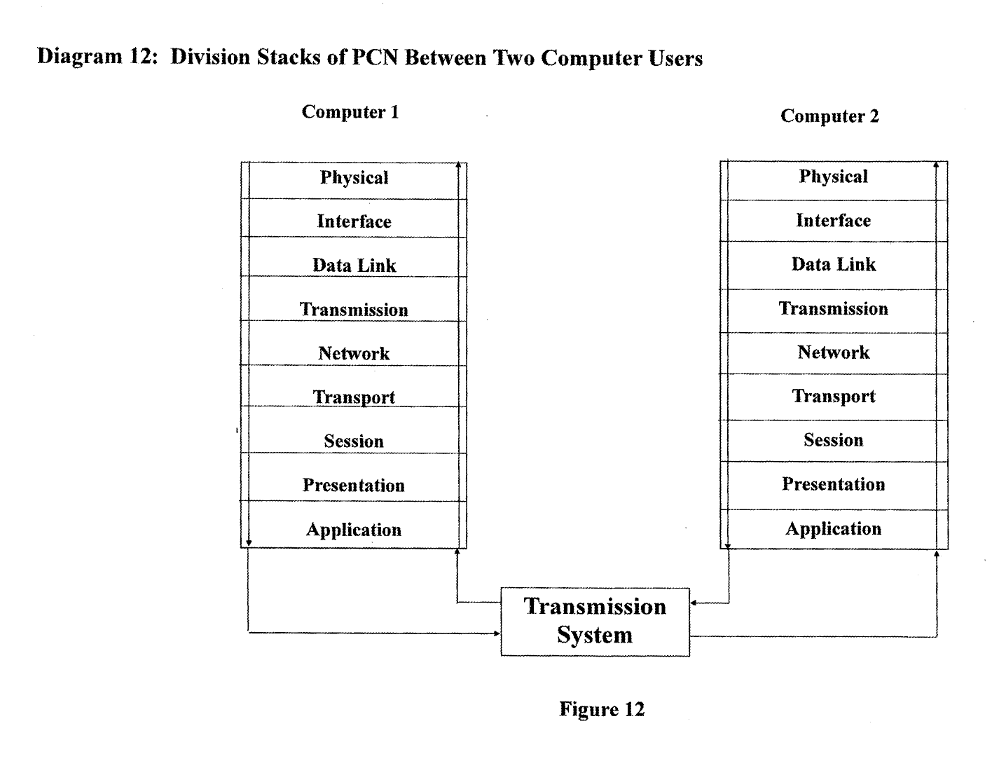

There are nine layers of the computer in the network of PCN (shown as FIG. 12). Among these nine layers, the layer of interface 20 is as important as any other layers. Both computer users 10 and mobile users 50 have this layer. It is important, because both computer users 10 and mobile users 50 can use this layer to define applications in classification and geography to have local search and global search and make the searching systems of PCN flexible, convenient, sufficient and efficient.

The layer of transmission of PCN is using router to transmit the data between the user 10 and operating system of PCN. The feature is determined by architecture of the network that we need use the router for transmitting the data between user and operating system.

### Universal Platform of Operating System of PCN

The configuration of Application Control Unit 70 has been shown in FIG. 9. One of the functions of Application Control Unit 70 is to provide a universal platform for all application systems, such as Windows, UNIX, and Mac and so on and unify different application systems to the standard platform and enable different application systems to work in the same network. The universal platform for mobile users 50 in mobile computing system 120 not only unifies all applications in the network for mobile users 50 to provide the mobile users 50 with sufficient applications in the network, but also unifies different mobile systems to the standard platform and enable them to work in the same network.

The computer users 10 and mobile users 50 only need to download the standard platform in their computers 10 or mobile devices 50 to employ all the applications with different system in the network of PCN.

Can either standard platform for computer users 10 or standard platform for mobile users 50 be designed and developed. Therefore, converting interface can be designed to convert each different system into PCN standard system. The conversion from application system into PCN standard platform will happen after Application Control Unit connects the application server 40 logically to operating system.

### Application Server and Applications

In PCN, all the applications will be developed in servers, called Application Server 40. It was also called in previous application (Ser. No. 61/962,311) Individual Business Server, Business Server, and Business Information Server. It can be an application server for single business, such as Application of Microsoft, Application of Amazon. It also can be an application server combining many some small business applications in same geography or in same classification or nothing in common. For example, Application of Local Business of Hershey, Pa. which combines the local business and services in Hershey PA, and application of Cancer Treatments, which combines some specialized cancer treatment facilities.

Application Server 40 has a name, but users don't have to know. Application server's 40 name can be duplicated, and it can be same as one of its applications in the server. But, duplicated named Application Servers 40 have different identities and addresses in the network.

All applications have names in the network of PCN. Their names can't be duplicated, since application names are used to search. The application can be in multiple application servers 40 for search. However, it need have these application servers' identities to identify itself which application server 40 it is at.

Application Server 40 contains an identity of Application Server 40. Application Server 40 doesn't have to contain the code(s) of classification in its identification number. However, applications in the application server 40 must have same identity as the application server to identify them which application server 40 they are at. The identification numbers of the applications in application server must contain the code(s) of defined classification.

Some applications can be found in multiple application servers 40. It requires that the applications that can be found in multiple application servers 40 must contain all the identities of the application servers they are at.

The application has to contain some important factors: one is the identity of the application server 40 which the application is at; another one is the code of classification of application. With the code of classification, operating system will find the application; with the identity of application server, operating system can rely on the identity of application server 40 to connect it.

Application Control Unit 70 and Initial Server 80 cooperating with Network Directory 20 in the interface 20 can search the applications by the codes of classification locally when both classification and geography of application are defined, and globally when only classification is defined and geography need be defined by operating system logically. That is why we need define the coverage of some applications and application servers so that operating system can define the geography efficiently.

The application servers have three types: One is the application server 40 for the major company, like “Microsoft”, “Google”, “Amazon” and so on. The users can use their products, looking for their business information, and have some commercial conducts. Themselves, they can expand and extend their business in the application server to provide more services for the users in the network. The second one is combining some businesses and develops them into same application server. The third type is the application server 40 for users to search their information only, such as “White House of United States”, “Library of Congress” and so on. All application servers in the network of PCN can expand and extent their business flexibly, and conveniently.

The designs of Application and Application Server 40 can make the network well organized, expanded and extended conveniently, and able to be developed a mature, secure, and efficient network.

### Inner Connection

The patent application “Network Architecture of Fixed Routing” (Ser. No. 61/962,311) discusses the identification numbers which identify elements in operating system. Same elements of operating system in two different locations have same identification numbers, in order to increase the efficiency of the network. The country code and area code should be defined to identify operating system of the network.

Based on the definition of country codes, area codes and identification numbers of elements in the network, Inner Connection can be established to increase the efficiency of the performance in the network.

Inner connection is defined for the connection between two same elements with same identification numbers but different country codes or area codes, or two different elements in same operating system with same country code or area code in same operating system.

Because of the efficiency of the network that the transit of packets is no longer in bit stream, and the transit of packets in PCN can be designed in packet stream per session, the feature of Inner Connection in PCN to change only partial of the address of receiver can make the network unbelievable efficient and new technologies can be developed, including that the coding of data can be reformed.

In a word, with the advantage of Inner Connection, the efficiency of PCN will be improved more rapidly, and the network of PCN can be developed in mature.

### Public Branch Network Exchange (PBNX)

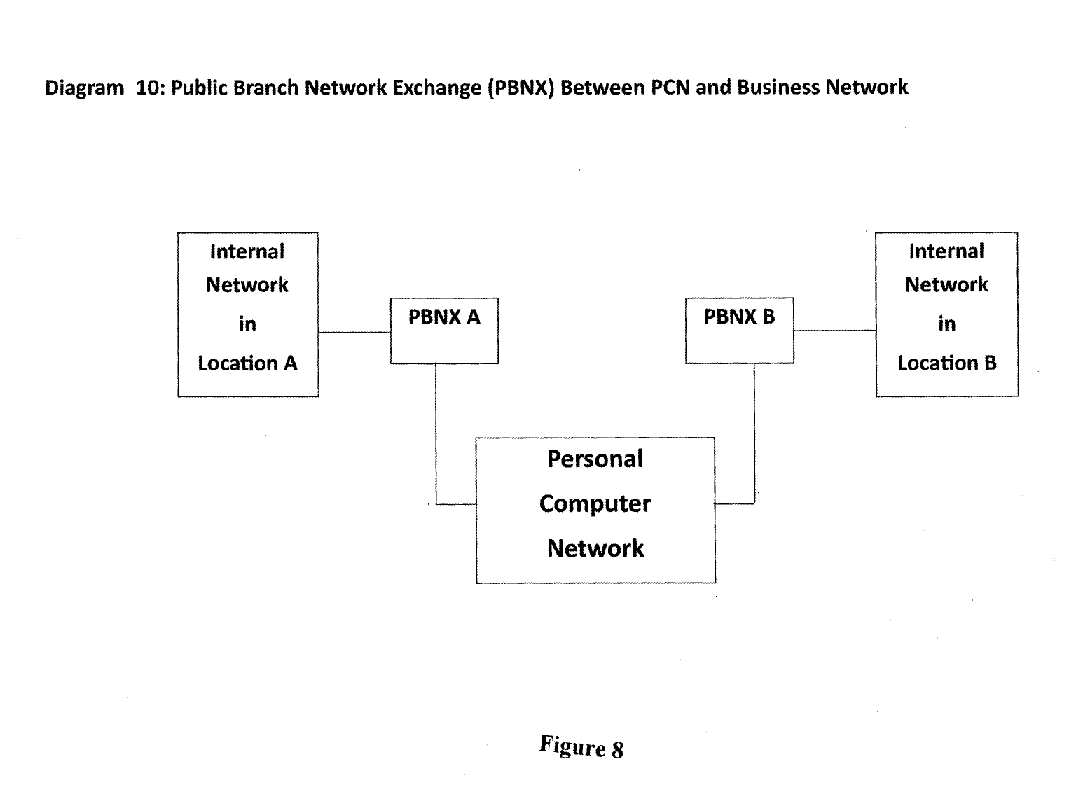

A switch device that we name it Public Branch Network Exchange (PBNX) can be used to connect the internal business network to PCN. The detailed design will be submitted in another patent application “Public Branch Network Exchange” (shown as FIG. 8).

With PBNX, the company's internal network can be considered as a network user connecting to PCN with router and PCN will assign Internal Business Network a protocol, called Network Business User Protocol (NBUP).

Network Business User Protocol is defined to identify the internal business network in PCN by Networking Unit of operating system in PCN.

Users of Internal Business Network can use PCN same as personal computer user. The uses of internal business network can use PCN as same as personal computer users that their servers and computers will be configured in the same way as personal computer users to use Network Directory to define the applications in classification and geography, and search locally and globally.

1. The network of PCN will centralize the services, functions and features of the network in Local Servers, Regional Servers and Global Servers, and the computer users in the network are to receive the services, comprising:

[symbol]

2. The system of claim 1: Both user's computer workstations and the interface will be configured and collaborate with the services, functions and features of the network of PCN. Pull-Down and Pull-Up (Start Manuals) manuals indicate the services that the user can choose (Shown as FIG. 7-1A and 7-1B). With the configuration of Pull-down manuals, the user can manage the files and communicate with the network service provider, while the services of Pull-up manuals (start manual) will be configured the computers with the services, functions and features of the network of PCN.

3. The system of claim 1: The user's computer and the interface need have a universal operating system and need be configured with the functions of HTTP, HTML, FTP, SMTP and other protocols to receive the services and files.

4. The system of claim 1: the network of PCN will be configured in order to collaborate with the applications. There is a standard display page frame (shown as FIG. 7-7) designed and configured to present the applications. The standard display page will be also configured to perform the functions and features of the network, such as Local Searching and Global Searching, so that the standard display page can be used to switch the searching systems. The applications in HTTP format will be designed with HTML language and fits into the configured display page frame.

5. The system of claim 1: The interface will be configured with the functions of HTTP, FTP, SMTP and other protocols to receive the services and files from application servers. The HTML language is used to design the application pages and to link interactively in the network of PCN HTTP, FTP, SMTP and other protocols configured in the interface of the user's computer workstations are not necessarily configured with the fully functions of browsers used for the searching systems in the network of PCN. This concept can be used widely in the network of PCN that the functions and features used in Internet network today can be separately used for the users and the network of PCN.

6. The system of claim 1: The computer user uses the interface to communicate with the network of PCN. The interface will not only be configured with HTTP, HTML, FTP, SMTP and other protocols to receive the services and files from the network, but also be configured by the network for the special applications, such as Public Applications, Private Applications including Customized Applications and Secret Applications. How to configure the interface to collaborate with the network is discussed in the claim of applications.

7. The system of claim 1: the Network Protocol in Local Server of PCN not only communicates with the interface of the user's workstations, but also communicates with the hosts inside the network.

8. The system of claim 1: The applications in the network are defined as Public Applications, Private Applications and Secret Applications. The transfer between the Public Application and Private Application will occur with HTML link in the pages of Public Application, Private Applications, or the standard display page, as well as the front page with Start Manual. The transfer between Local Searching and Global Searching will occur either with Start Manual, or the standard display page which is to display applications. The detail will be discussed in the claim of Local Searching and Global Searching.

9. The system of claim 1: As same as the manner to network the computer users, the data transmitted between the user and the network need be modulated before compressed in order to increase the network efficiency and security.

10. The system of claim 1: The data structure of centralized network has a feature that data between the interface of user and Local Server is different from the data flowing inside the network. The data between the user and the network has the indications of the workstations and applications. The network will keep the indications of the workstations in Local Server, and form the data for each application to communicate with each host inside the network.

11. The System of claim 1: The network uses the standard network codes inside the network. For example, the short format of data indicating a customized application can be used to represent a customized application which the user orders for the data between the interface and the network, but, it can be replaced with the completed indication of the customized application which is a standard network codes to represent the whole services of the customized application. The detail is discussed in the claim of applications with an example of Home Security System.

12. The system of claim 1: Six layers of TCP protocols are defined for the transmission protocols in the network of PCN. There are three different transmissions in the network. One is from the user and the Local Server; the second is between two hosts inside the network, and the third is from the network to the computer user. The transmission between the interface and Local Server has different data structure from the transmission between two servers inside the network. The transmission control protocol, including the interface of the user's workstations will control the incoming and outgoing data separately. The Network Protocol will control incoming and outgoing data separately not only with the interface, but also with the hosts inside the network.

13. The system of claim 1: TCP Availability Server which contains the information of the status of TCP protocols is defined for Application Server to determine the fixed routing. The detail about TCP Availability Server is discussed later in the claim of TCP Availability Server.

14. In the network of PCN, there will be three kinds of applications: One is Public Applications, the second is Private Applications, and the third is Secret Applications. The network will have a standard display page frame to present all these three kinds of applications. The display page frame will be configured for the user to manage the files, switch the services, functions and features conveniently. The network will also be configured to collaborate with these different kinds of applications, and will also configure the interface of the user's workstations to communicate with the network, comprising:

[symbol]

15. The system of claim 14: for all the public applications, private applications and secret applications, a standard display page frame is defined to present all the applications. All the applications can be designed and displayed in the page frame with HTML language. The standard display page frame is also configured for users to manage the files, change the services, and choose the features of the network conveniently. In the second patent application, we have defined that we can transfer searching system either from Start Manual or in the network. The configurations of the standard display page frame will enable the user to switch the searching method in the network.

16. The system of claim 14: as one kind of applications of PCN, Public Applications are provided by the network itself, as Private Applications are connected to the network of PCN. The public applications include some important and typical services, such as: News, Finance, Sport, Weather and email, and so on. Public Applications, in fact, are an application server. In the network of PCN, we don't have to have such many email service providers, and email service in the network of PCN should be considered as mail service provided by USPS today.

17. The system of claim 14, since Public Applications are provided by the network itself, we only need to configure the interface of the user's workstations to communicate with the network in order to apply the public applications. In the second patent application, we have defined that all the applications will be presented with HTTP format same as internet today. HTML function will be used to transfer the public application to the private application. The configurations of HTTP, FTP, SMTP and other protocols used for Public Applications can also be used for Private Applications and Secret Applications.

18. The system of claim 14, the public applications will be presented to the computer users as soon as they login the network. The public applications will be same as today's home website of internet to the computer users, and can be considered as basic services of the network. The reason that we define the public applications independently from other applications is because we need an authority to present, manage and control the services, such as news, email, and so on responsibly in the network of PCN.

19. The system of claim 14, there are HTML links in the pages of the public applications for the users to transfer from the public application to the specific private application. The user can also use the configuration of the standard display page frame of the network of PCN to launch a private application searching locally or globally.

20. The system of claim 14, besides the public applications, Private Applications are logically connected to the network of PCN. Private applications include the regular applications and customized applications. The customized applications are defined for the unique applications in the network. The computer user needs to specifically order them to Network Service Provider, such as “Home Security System”.

21. The system of claim 14, the customized applications are defined for the products used today in our lives. They can be found in the internet, but they are not used with the internet, or with the internet completely, such as Home Security System. After the network is developed, Home Security System can be computerized and networkized with the network of PCN. We need to configure the network according to the functions and features of the application of Home Security System. When the computer user orders the service of Home Security System from the service provider of the network of PCN, the network will configure the interface of the user's interface so that the user can receive the service of Home Security System from the network.

22. The system of claim 14, the network of PCN has a module designed unit called Customized Application Configuration Unit. The unit is not only connected to the computer user directly, but also connected to Network Unit, Application Control Unit and Application Servers to cooperate and collaborate for the functions and features of the customized application (shown as FIG. 7-2).

23. The system of claim 14, for the Home Security System application, more than one workstations may be involved, such as the camera, alarm system and so on. In the data structure between the user and the network, there will be the workstation indications, so that the camera and alarm system can be controlled to function by the interface.

24. The system of claim 14, the network of PCN can be configured to directly connect the private application to the user's computer with Customized Application Configuration Unit. For example, when a football fan likes his favorite football team's information showing in his computer with a click away, he can order his favorite team's application as special application to the provider of the network of PCN. Then, the application will be customized with the setting connecting to the computer user without searching.

25. The system of claim 14, there are some applications that can't be exposed to the public. Only authorized personnel can access to the secret applications from his own computers or from any computer. By configuring the authorized personnel's computer and/or the account, the network of PCN can enable them to access the secret applications.

26. The network of PCN has a feature that it can perform the local searching and global searching in the network by defining the location and classification of the application in the interface and the standard web page in the network. It also has defined that the local searching and global searching can be transferred with the configurations, comprising:

[symbol]

27. The system of claim 26, the start manual (Pull-up manual, shown as FIG. 7-1) has been configured in the user's computer and interface by the network. It lists all the services, functions and features of the network, including Local Searching and Global Searching. The user can go to start manual to choose the searching method.

28. The system of claim 26, the standard display page is designed (shown as FIG. 7-5) and configured for changing of service. To change Local Searching to Global Searching or to change Global Searching to Local Searching, we only need to click at “Searching Systems”. It is a pull-down manual indicating the services of searching systems. After clicking the service, we can choose the service and be led to next page of the service to define the classification or location, or both.

29. The system of claim 26, There can have many features of the searching systems. The configuration of the standard display page can be defaulted with the previous location and classification. When we use the standard display page frame to change the searching method, we don't have to enter the location if we still like to stay in local searching in the same location. If we like to stay in local searching, but we like to search another location, we still need to define the location. So is the classification.

30. In the first patent application of the network of PCN, we have defined that the network of PCN has a function to determine the fixed routing. To accomplish the fixed routing, we define and design a server, called TCP Availability Server which contains the information of status of TCP protocols, comprising:

[symbol]

31. The system of claim 30, TCP Availability Server is a server containing the information of all the TCP protocols in the country. It is defined for the application server to determine the fixed routing in its own country. As soon as the data arrives at Foreign Global Server, the host in Foreign Global Server will determine the fixed routing in its own country. Therefore, each country will have its own TCP Availability Server.

32. The system of claim 30, The status of TCP protocols in TCP Availability Server include: idle, busy, error, and time of packet transmission T1, time of queuing and processing T2, and time of delay T3. Each status can be considered static or dynamic relatively. For example: the status of “busy” can be considered as static, i.e., it is simply busy. However, how long the status can become idle will depend on the current transmission time and the next transmission(s) time. It is changed to dynamic because the error and delay could happen, and the time of packet transmission could vary. The fixed routing could be static or dynamic as well based on the status of the TCP protocols. The static fixed routing only happens when all the protocols in the routing are idle.

33. The system of claim 30, there are three functions of TCP Availability Server. One is to dynamically record and update the status of the protocols in the network of PCN by connecting to the TCP protocols logically. The second is to provide the information of the status of TCP protocols to the application server to determine the fixed routing in the country. The third is to manage and organize the status of TCP protocols physically and logically in order to enable application server connected to it to retrieve the information easily. For example, TCP Availability Server can organize the status of TCP protocols in Local Servers, Regional Servers and Global Servers for the application server to determine the fixed routing in long distance. TCP Availability Server can also organize the status of TCP protocols in the region for the application server to determine the fixed routing in short distance.

34. The system of claim 30, More than one kind of TCP may be used in the network of PCN, such as Async, Bisync, or SNA to increase the efficiency of the network of PCN. Therefore, more than one kinds of TCP Availability Server will be designed for their own TCP protocols.

35. Based on the definition of the network of PCN shown as FIG. 3 in the first patent application “Network Architecture with Fixed Routing”, how the computer users and the network of PCN communicate each other globally has shown in FIG. 7-6. We use an example to indicate the functions of the network of PCN, comprising:

[symbol]

36. The system of claim 35, as shown in FIG. 7-6, we have an interface to group, process and control the workstations at home, such as computer stations, television station, cable station, telephone and so on. Both User A and User D in FIG. 3 have their interfaces to group, process and control their workstations at home and communicate with their Local Servers. In PCN, the television and cable will be considered as two applications. We don't think it practical for the cable company to pay two media companies (television company and network company), if cable company wants to networkize with PCN. From the aspect of management, the applications connected to the network of PCN should be independent, even though they are all developed in the server. However, if two companies join to make a new product, the product should be connected to the network of PCN independently. It is very important to keep the network in simply and clear structure. For this purpose, the governments should have rules and regulations to protect the network of PCN from any kind of pollutions and attacks.

37. The system of claim 35, as shown in FIG. 7-6 and FIG. 3 in the first patent application, the network of PCN consists of user's workstations, interfaces, Local Servers, Regional Servers and Global Servers, as well as the transmission system.

38. The system of claim 35, if we assume the User A is in New York City connected to Local Server with area code 718. In the region of New York City, there are several Regional Servers and one Global Server with area code 917. User D is in Shanghai, China connected to Local Server with area code 6567. Same as New York City, there are several Regional Servers and one Global Server in the region of Shanghai. If User A sends an email to User D, SMTP protocol at 718 Local Server will send the email to SMTP protocol at 6567 Local Server with the rules and the information provided by TCP Availability Server to determine the fixed routing.

39. The system of claim 35, the rules say that Local Server can only communicate with Regional Servers in the region; Regional Servers can only communicate with Global Servers in the region and all Regional Servers in the country; Global Server can only communicate with Regional Server in the region and all Global Servers in the country and overseas. In this example, the routing for User A in his country to send an email to User B can be: 718-347-917; 718-347-415-510; and 718-347-917. In User B's country, the routing can be: 6545-6145-6567; 6422-6802-6145-6567; and 3708-6374-6145-6567.

40. The system of claim 34, TCP Availability Server contains information of status of the protocols of all these Local Servers, Regional Servers and Global Server, and help Email Application Server determine the fastest, safest or the most efficient fixed routing. TCP Availability Server will group all the SMTP protocols' information, and Email Application Server will detect all the routing's time, errors, transmission time, processing time and risks to determine the best fixed routing.
